(19) United States
(12) Patent Application Publication
(10) Pub. No.: US 2003/0046084 A1
(43) Pub. Date: Mar. 6, 2003

(54) Method and apparatus for providing location-specific responses in an automated voice response system

(76) Inventor: Blair Wyman, Rochester, MN (US)

Correspondence Address: Grant A. Johnson, IBM Corporation - Dept. 917, 3605 Highway 52 North, Rochester, MN, 55901, US

(21) Appl. No.: 09/941,112

(22) Filed: Aug. 28, 2001

(51) Int. Cl. G10L 21/00

(52) U.S. Cl. 704/275

(57) ABSTRACT

A method, apparatus and computer program product provide location-specific responses in an automated voice response system. A microphone signal is received from each of a plurality of microphones. The microphones are located within a defined environment. A spoken command is identified utilizing voice recognition responsive to the received microphone signals. A sound origin or sound location vector is identified responsive to each identified spoken command from respective ones of the plurality of microphones. A response command is provided based upon the identified sound location vector.

### FIELD OF THE INVENTION

The present invention relates generally to the data processing field, and more particularly, relates to a method, apparatus and computer program product for providing location-specific responses in an automated voice response system.

### DESCRIPTION OF THE RELATED ART

Systems capable of performing speech recognition are known in the prior art. For example, known systems respond to a spoken word by producing the textual spelling, or some other symbolic output, associated with that word.

The automatic recognition of spoken speech can be used for many applications. For example, a voice recognition system may be used for controlling a plurality of different devices.

A need exists for an automated, flexible and efficient voice response system. It is desirable to provide such an automated, flexible and efficient voice response system for controlling a plurality of different devices. It is desirable to provide such an automated, flexible and efficient voice response system including location-specific responses for controlling a plurality of different devices.

### SUMMARY OF THE INVENTION

A principal object of the present invention is to provide a method, apparatus and computer program product for providing location-specific responses in an automated voice response system. Other important objects of the present invention are to provide such method, apparatus and computer program product for providing location-specific responses in an automated voice response system that efficiently and effectively facilitates a determination of an intent of a spoken command; to provide such method, apparatus and computer program product substantially without negative effect; and that overcome many of the disadvantages of prior art arrangements.

In brief, a method, apparatus and computer program product are provided for providing location-specific responses in an automated voice response system. A microphone signal is received from each of a plurality of microphones. The microphones are located within a defined environment. A spoken command is identified utilizing voice recognition responsive to the received microphone signals. A sound origin or sound location vector is identified responsive to each identified spoken command from respective ones of the plurality of microphones. A response command is provided based upon the identified sound location vector.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a processor automated voice response system for implementing location-specific responses in accordance with the preferred embodiment;

FIG. 2 is a more detailed diagram illustrating the automated voice response system for implementing location-specific responses of FIG. 1 in accordance with the preferred embodiment;

FIGS. 3 and 4 are diagrams illustrating exemplary details of the digital analysis unit of the automated voice response system for implementing location-specific responses in accordance with the preferred embodiment;

FIG. 5 is a flow chart illustrating exemplary sequential steps for implementing location-specific responses in an automated voice response system in accordance with the preferred embodiment; and

FIG. 6 is a block diagram illustrating a computer program product in accordance with the preferred embodiment.

### DETAILED DESCRIPTION OF THE PREFERRED EMBODIMENTS

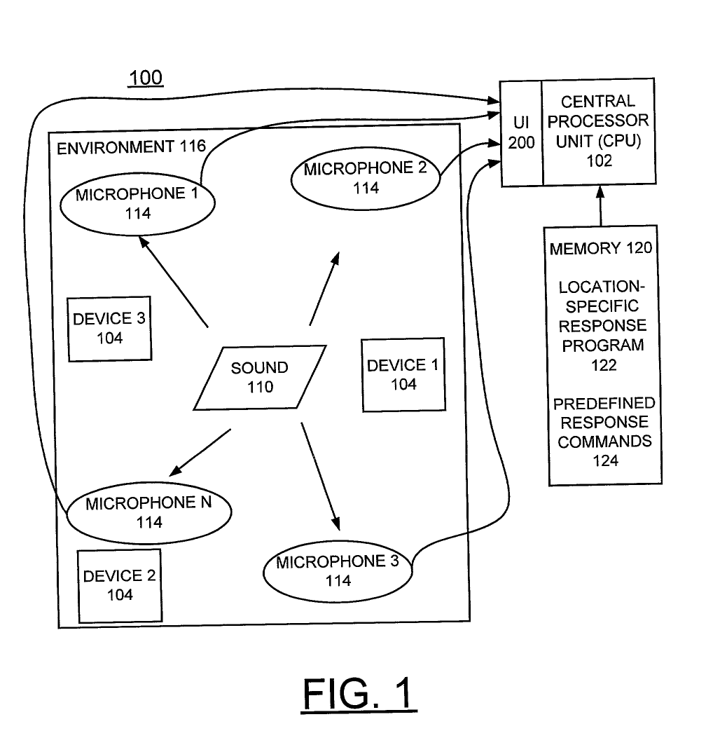

Having reference now to the drawings, in FIG. 1, there is shown an automated voice response system of the preferred embodiment generally designated by the reference character 100. As shown in FIG. 1, automated voice response system 100 includes a processor or central processor unit (CPU) 102. CPU 102 is adapted for selectively controlling at least one of a plurality of different devices 1-3, 104 responsive to an identified spoken command indicated by block labeled SOUND 110. A user interface (UI) 200 connects the CPU 102 to a plurality of microphones 1-N, 114 located within an environment 116 wired with the microphones. User interface (UI) 200 also operatively couples the CPU 102 to the plurality of different devices 1-3, 104 to selectively provide predefined controlled operations of the devices 104. The automated voice response system 100 includes a memory 120 storing a location-specific response program 122 of the preferred embodiment and a plurality of predefined response commands 124 issued by CPU 102 for operatively controlling the devices 1-3, 104.

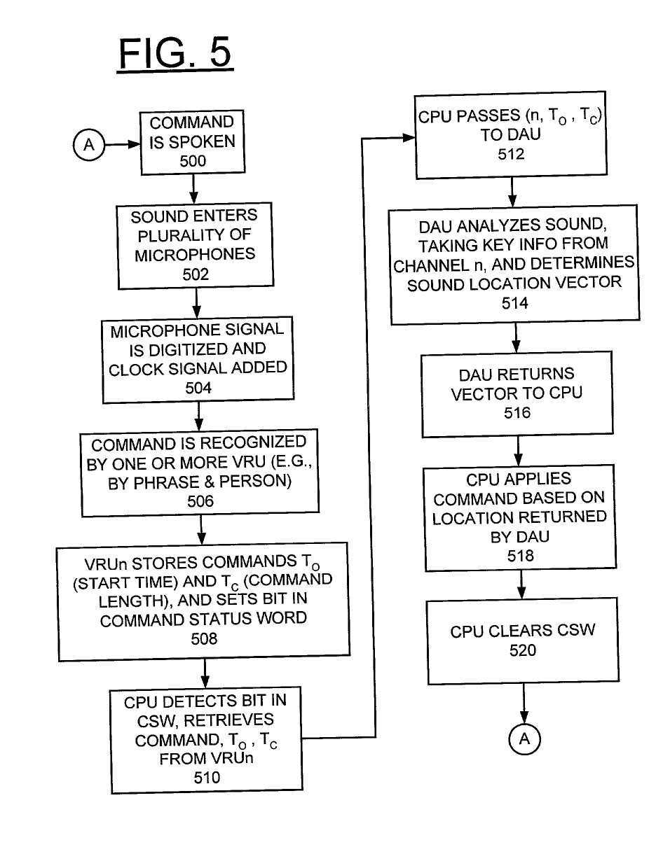

Central processor unit 102 is suitably programmed to execute the flow chart of FIG. 5 of the preferred embodiment for implementing location-specific responses of the preferred embodiment. The processor automated voice response system 100 may be implemented using any suitable processor system, or computer, such as an IBM personal computer running the OS/2® operating system.

In accordance with features of the invention, the automated voice response system 100 processes a sound input from the microphones 1-N, 114 performing voice recognition to identify spoken commands and signal analysis to identify the location of a sound's origin within environment 114. The identified physical location of the person uttering a spoken command is used as a discriminating criterion by the automated voice response system 100 to select one of the stored automated response commands 124 for controlling different devices 1-3, 104.

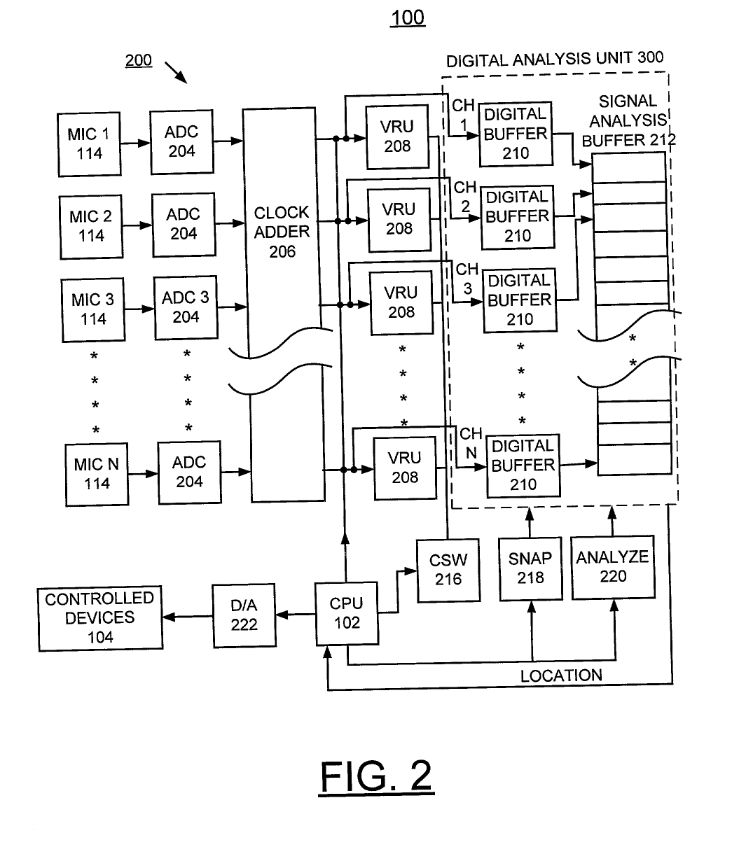

Referring now to FIG. 2, the automated voice response system 100 including user interface 200 is shown in more detail. User interface 200 includes a respective analog-to-digital converter (ADC) 204 coupled to each of the microphones 1-N, 114. ADC 204 receives and digitizes an analog audio signal from its associated microphone 114 and applies the digitized audio signal to a clock adder 206. A synchronized time signal is added by the clock adder 206 to the digitized audio signal and then applied to both a respective voice recognition unit (VRU) 208 and a respective channel input of a digital analysis unit 300. Digital analysis unit 300 includes a respective digital buffer 210 and a signal analysis buffer 212 for each respective channel input 1-N corresponding to digitized, clock added signals for the microphones 1-N, 114. A command status word (CSW) register 216 is connected to each VRU 208 and to the CPU 102. When a particular VRU 208 identifies a spoken command, a bit corresponding to the particular VRU 208 is set in the CSW 216. CPU 102 polls the CSW 216. When the CPU 102 detects that a bit has been set in the CSW 216, CPU 102 interrogates the corresponding VRU 208 for a command ID (CID), a start time of the command T₀, and a length of the command as a measure of time T_{c}. Upon receiving the command information, CPU 102 signals the digital analysis unit 300 via a snap block 218 and an analyze block 220 to analyze the identified spoken command signal. Digital analysis unit 300 returns a location vector to the CPU 102 indicated at a line labeled LOCATION. User interface 200 includes a respective digital-to-analog converter (DAC) 222 coupled between CPU 102 and each of the different devices 104 (one shown in FIG. 2). Responsive to the location signal provided by the digital analysis unit 300, CPU 102 then applies a location-specific response for selectively controlling at least one of a plurality of different devices 1-3,104.

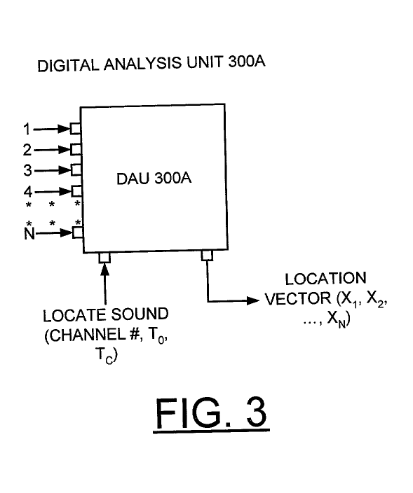

FIG. 3 illustrates an exemplary digital analysis unit 300A receiving channel inputs 1-N. CPU 102 provides a locate sound input including channel #, the command start time T₀, and the command length T_{c} to the digital analysis unit 300A. Digital analysis unit 300A provides a location vector (X₁, X₂, X₃, . . . Xₙ) of the origin of sound 110 in the environment 116 that is applied to the CPU 102.

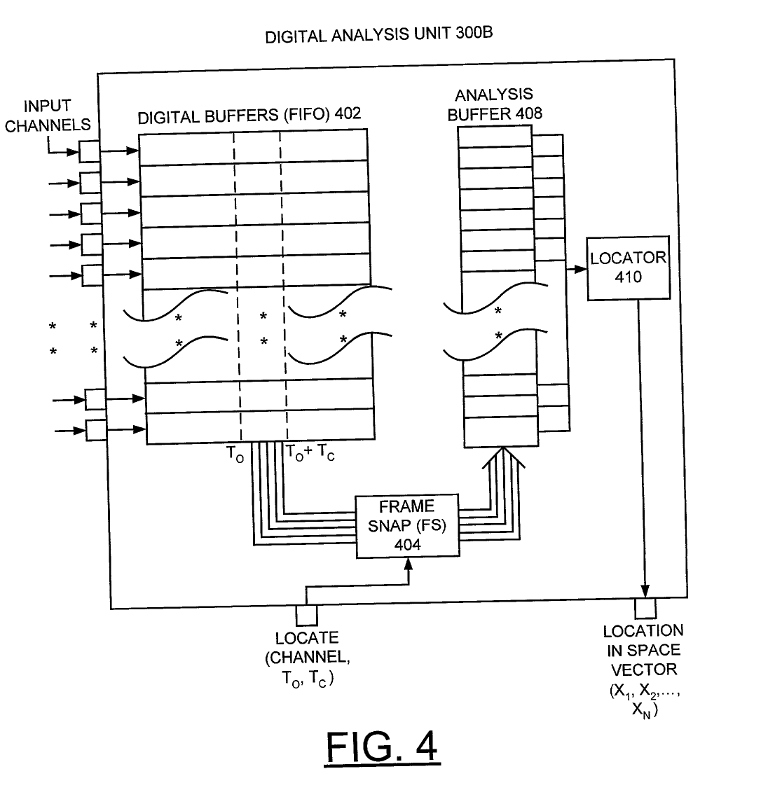

FIG. 4 illustrates another exemplary digital analysis unit 300B receiving channel inputs 1-N respectively coupled to a corresponding first-in first-out (FIFO) digital buffer 402. CPU 102 provides a locate sound input including channel #, the command start time T₀, and the command length T_{c} to a frame snap (FS) function 404 in the digital analysis unit 300B. An analysis buffer 408 is coupled to FIFO digital buffers 402 via the FS function 404. FS function 404 captures a region from the FIFO digital buffers 402 into the analysis buffer 408 for phase-relation analysis, performed by a locator function 410. Locator function 410 operates on the captured region from the FIFO digital buffers 402 in analysis buffer 408, extracting salient signal features, and determining the phase shift and volumes of input frequencies from respective microphones 114, thereby locating the origin of sound 110 in the environment 116. Digital analysis unit 300B provides a location vector (X₁, X₂, X₃, . . . Xₙ) that is applied to the CPU 102.

Referring now to FIG. 5, there are shown exemplary sequential steps for implementing location-specific responses in the automated voice response system 100 in accordance with the preferred embodiment. The sequential steps begin when a command is spoken as indicated in a block 500 and sound enters the plurality of microphones 1-N, 114 as indicated in a block 502. The microphone signal is digitized and a clock signal is added to the digitized microphone signal by a respective ADC 204 and the clock adder 206 as indicated in a block 504. A spoken command is recognized by one or more VRU 208 as indicated in a block 506. The spoken command identified at block 506 is limited to commands that start with a given phrase or prefix word, such as “computer”. Also, the spoken command identified at block 506 can be limited to commands spoken by a particular person. VRU 208 advantageously can be adapted to identify a particular person before certain spoken commands are processed, for example, in order to implement parental control of a particular device 104.

Each VRU 208 recognizing the spoken command at block 506, (VRUn), stores the command start time T₀, and the command length T_{c} for the identified command and sets a bit in the command status word (CSW) 216 as indicated in a block 508. CPU 102 detects the bit in the command status word (CSW) 216 and retrieves the command start time T₀, and the command length T_{c} for the identified command from the respective VRUn as indicated in a block 510. CPU 102 passes the VRU channel number n, the command start time T₀, and the command length T_{c} for the identified spoken command to the digital analysis unit (DAU) 300 as indicated in a block 512. DAU 300 analyzes the sound for each identified spoken command, taking key information from each VRU channel number n, and determines a sound location vector as indicated in a block 514.

DAU 300 analyzes the sound signal for each identified spoken command of each VRU channel number, for example, by comparing phases and/or volumes of input frequencies to locate the sound origin in space. DAU 300 returns the sound location vector (X₁, X₂, X₃, . . . Xₙ) of the origin of sound 110 in the environment 116 to the CPU 102 as indicated in a block 516. CPU 102 uses the sound location vector (X₁, X₂, X₃, . . . Xₙ) of the origin of sound 110 in the environment 116 to determine, for example, the validity, applicability, and intent of the spoken command. CPU 102 applies a particular command to controlled device 104 based upon the sound location vector (X₁, X₂, X₃, . . . Xₙ) as indicated in a block 518. Then CPU 102 clears the CSW 216 as indicated in a block 520. Then the sequential steps return to block 500 following entry point A for processing a next spoken command.

It should be understood that many variations of the exemplary steps performed by the automated voice response system 100 can be provided. One variation would be to only perform the location analyses when the identified spoken command indicates the location analyses is necessary. For example, the spoken command, “computer, lock up the house” would have no locational component, while the spoken command, “computer, lock this door” would have a locational component. Another variation would screen commands that originated from certain fixed locations, such as stereo speakers or intercoms, so that the location analyses would not be performed. Also the automated voice response system 100 can be arranged to process the microphone signal from one VRU 208, which was passed the loudest signal from the array of microphones inputs.

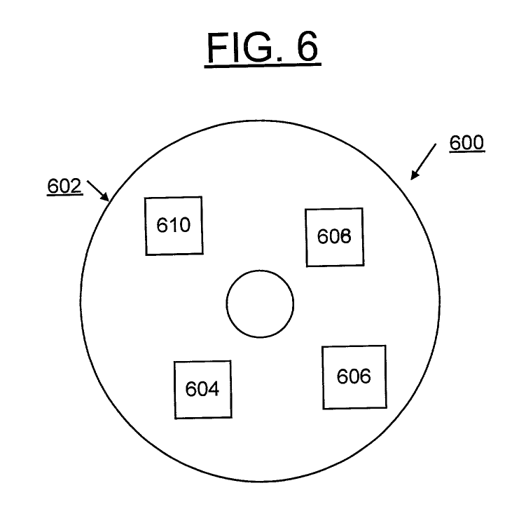

Referring now to FIG. 6, an article of manufacture or a computer program product 600 of the invention is illustrated. The computer program product 600 includes a recording medium 602, such as, a floppy disk, a high capacity read only memory in the form of an optically read compact disk or CD-ROM, a tape, a transmission type media such as a digital or analog communications link, or a similar computer program product. Recording medium 602 stores program means 604, 606, 608, 610 on the medium 602 for carrying out the methods for implementing location-specific responses in the system 100 of FIG. 1.

A sequence of program instructions or a logical assembly of one or more interrelated modules defined by the recorded program means 604, 606, 608, 610, direct the automated voice response system 100 for implementing location-specific responses of the preferred embodiment.

While the present invention has been described with reference to the details of the embodiments of the invention shown in the drawing, these details are not intended to limit the scope of the invention as claimed in the appended claims.

What is claimed is:

1. A method for providing location-specific responses in an automated voice response system, said method comprising the steps of:
receiving a microphone signal from each of a plurality of microphones;
identifying a spoken command utilizing voice recognition responsive to each said received microphone signal;
identifying a sound location vector responsive to each said identified spoken command; and
providing a response command based upon said sound location vector.

2. A method for providing location-specific responses in an automated voice response system as recited in claim 1 wherein the step of receiving a microphone signal from each of a plurality of microphones includes the steps of digitizing said microphone signal from each of a plurality of microphones; and adding a clock signal to each said digitized microphone signal.

3. A method for providing location-specific responses in an automated voice response system as recited in claim 2 wherein the step of digitizing said microphone signal from each of a plurality of microphones includes the step of applying an analog audio signal from each of a plurality of microphones to a respective analog-to-digital converter (ADC) coupled to each of said plurality of microphones.

4. A method for providing location-specific responses in an automated voice response system as recited in claim 3 wherein the step of adding a clock signal to each said digitized microphone signal includes the step of applying a digitized audio signal from said respective analog-to-digital converter (ADC) to a clock adder for adding said clock signal.

5. A method for providing location-specific responses in an automated voice response system as recited in claim 1 wherein the step of identifying said spoken command utilizing said voice recognition responsive to said received microphone signal includes the steps of identifying a predefined first command word of predetermined spoken commands.

6. A method for providing location-specific responses in an automated voice response system as recited in claim 1 wherein the step of identifying said spoken command utilizing said voice recognition unit responsive to said received microphone signal includes the steps of identifying said received microphone signal for a predetermined person and identifying said spoken commands only from said identified predetermined person.

7. A method for providing location-specific responses in an automated voice response system as recited in claim 1 wherein the step of identifying said spoken command utilizing said voice recognition responsive to said received microphone signal includes the steps of storing a command start time T₀, a command length T_{c} for said identified spoken command and a channel number corresponding to one of said plurality of microphones utilizing said voice recognition.

8. A method for providing location-specific responses in an automated voice response system as recited in claim 7 wherein the step of identifying said sound location vector responsive to said identified spoken command includes the steps of performing digital signal analysis of said identified spoken command utilizing said command start time T₀, said command length T_{c} for said identified spoken command and said channel number.

9. A method for providing location-specific responses in an automated voice response system as recited in claim 8 wherein the step of identifying said sound location vector responsive to said identified spoken command includes the steps of performing digital signal analysis of each said identified spoken command for each said stored channel number.

10. A method for providing location-specific responses in an automated voice response system as recited in claim 1 wherein the step of providing said response command based upon said sound location vector includes the step of determining an intent of said identified spoken command utilizing said sound location vector.

11. A computer program product for providing location-specific responses in an automated voice response system including a processor, said computer program product including a plurality of computer executable instructions stored on a computer readable medium, wherein said instructions, when executed by a processor, cause the processor to perform the steps of:
receiving a digitized audio signal from each of a plurality of microphones;
utilizing voice recognition to identify a spoken command responsive to said received digitized microphone audio signal from each of a plurality of microphones;
identifying a sound location vector responsive to each identified spoken command; and
providing a response command based upon said sound location vector.

12. A computer program product for providing location-specific responses in an automated voice response system as recited in claim 11 wherein said instructions, when executed by said processor, further cause the processor to perform the steps of storing a command start time T₀, a command length T_{c} for said identified spoken command and a channel number corresponding to an identified one of said plurality of microphones for each identified spoken command utilizing said voice recognition.

13. A computer program product for providing location-specific responses in an automated voice response system as recited in claim 12 wherein said instructions, when executed by said processor, further cause the processor to perform the steps of performing digital signal analysis for each identified spoken command utilizing said stored command start time T₀, command length T_{c} for said identified spoken command and said channel number of each identified one said plurality of microphones for each identified spoken command for identifying said sound location vector.

14. A computer program product for providing location-specific responses in an automated voice response system as recited in claim 12 wherein said instructions, when executed by said processor, cause the processor to perform the steps of selecting one of a plurality of predefined response commands utilizing said sound location vector to provide said response command based upon said sound location vector.

15. Apparatus for providing location-specific responses in an automated voice response system comprising:
a plurality of microphones located within a defined environment for receiving a sound within said environment and each of said plurality of microphones providing a microphone signal;
a processor for identifying spoken commands responsive to each said microphone signal and for identifying a locational origin of said spoken command within said environment; and
said processor for providing a response command based upon said identified locational origin of said spoken command within said environment.

16. Apparatus for providing location-specific responses in an automated voice response system as recited in claim 15 includes a respective analog-to-digital converter coupled to each of said plurality of microphones, each respective analog-to-digital converter receiving an analog audio signal and providing a digitized audio signal.

17. Apparatus for providing location-specific responses in an automated voice response system as recited in claim 16 includes a clock adder coupled to each said respective analog-to-digital converter for adding a clock signal to each said digitized audio signal.

18. Apparatus for providing location-specific responses in an automated voice response system as recited in claim 17 includes a respective voice recognition unit receiving each said digitized audio signal with said added clock signal; said voice recognition unit identifying said spoken commands; said processor retrieving said identified spoken commands from said respective voice recognition unit.

19. Apparatus for providing location-specific responses in an automated voice response system as recited in claim 18 includes a digital analysis unit utilizing said identified spoken commands from said respective voice recognition unit and identifying said locational origin of said spoken command within said environment; digital analysis unit applying said identified locational origin of said spoken command to said processor.

20. Apparatus for providing location-specific responses in an automated voice response system as recited in claim 19 wherein said processor selecting one of a plurality of predefined response commands utilizing said spoken command locational origin to provide said response command.
